(19) United States
(12) Patent Application Publication
(10) Pub. No.: US 2004/0153712 A1
(43) Pub. Date: Aug. 5, 2004

(54) Technical support systems and methods for use in providing technical support

(76) Inventors: Eric Owhadi, Tomball, TX (US); Rajpal Gill, Rocklin, CA (US)

Correspondence Address: HEWLETT-PACKARD COMPANY, Intellectual Property Administration, P.O. Box 272400, Fort Collins, CO, 80527-2400, US

(21) Appl. No.: 10/652,892

(22) Filed: Aug. 29, 2003

(30) Foreign Application Priority Data
Aug. 30, 2002 (EP) 02354124.6

(51) Int. Cl. H02H 3/05

(52) U.S. Cl. 714/4

(57) ABSTRACT

A method of obtaining technical support for a data-processing device, comprising initiating a support session during which device-specific data is conveyed from the device to a support provider to assist the support provider in responding to a support query, and polling the support provider for a response to the query, on a repeated and automated basis, until a response becomes available or the support session is terminated.

### FIELD OF THE INVENTION

This invention relates, in general terms, to the field of technical support systems which are used to provide users of electronic devices, data processing apparatus and computer systems with post-sale technical support, whereby software, hardware or other operational problems and difficulties may be resolved without the need for the user to return the equipment to the point of sale or to take the apparatus to a workshop or the like.

### BACKGROUND TO THE INVENTION AND SUMMARY OF THE PRIOR ART

Whilst a variety of technical support systems are known, a particularly common type is known as “Active Messaging”, a web-based support feature that allows users to submit support “calls” using the internet (web) as the principal interface. Broadly speaking, two kinds of Active Messaging implementations are known.

The first relies upon a user pre-loading a substantial piece of software that is designed to provide support features and front end functionality to the end user, but this requires a user to effect a software download, which many internet users are reluctant to do, not least in view of security concerns. In addition, this approach does not readily allow users to be alerted when their particular query has been addressed by a support technician.

The second system is more web-based, in that data harvesting engines can be downloaded from a support server to collect configuration information, in parallel with the support call. “Support Fetchdog”, a remote/local software diagnostic tool available from 4Developers LLC (www.4developers.com) incorporates a variety of data harvesters, known as “Configuration Fetchers”, each having a data footprint of about 108 KB.

By way of background U.S. Pat. No. 6,145,096 (Motive Communications, Inc.) discloses a problem solving method in which a diagnostic map is executed to explore a client machine and gather data, with a data set thus being generated which is indicative of a current operating state of the client device. The data set is then forwarded from the client device to a diagnostic server for analysis, with additional diagnostic maps being used, on an iterative basis, until enough information is available to a user of the client device to correct the given technical problem.

### SUMMARY OF THE INVENTION

In accordance with a first aspect of the present invention, there is provided a method of obtaining technical support for a data-processing device, comprising initiating a support session during which device-specific data is conveyed from the device to a support provider to assist the support provider in responding to a support query, and polling the support provider for a response to the query, on a repeated and automated basis, until a response becomes available or the support session is terminated.

The polling is preferably effected by a polling application obtained from the support provider.

The polling application, during the support session, may be executed subsequent to each boot or start-up sequence of the device. The application may be stored on or on behalf of the device, in a manner whereby the application is executed subsequent to each boot or start-up sequence of the device.

In a Windows O.S. environment, a Run key located in or operatively associated with a registry of the device may be used to execute the application, subsequent to each said boot or start-up sequence. Other O.S. environments are of course envisaged.

Upon termination of the support session, the Run key preferably is removed or disabled.

Preferably, the application subsequently is deleted using a delete command executed in accordance with a Run Once key located in or operatively associated with the registry.

The support session may be established using a web connection, the polling application being downloaded from the support provider using an applet. The applet, which may be a Java applet or “Active X” code, for example, may be executed from within a browser

The applet may be operative to download a data harvester to gather the device-specific data.

The applet preferably is used only in response to an indication of trust being given by a user of the device.

The support provider may convey to the user a trust request, agreement to the request allowing execution of the applet.

The polling application may monitor response availability by detection of an appropriate flag, the polling preferably being effected using HTTP.

In accordance with a second aspect of the present invention, there is provided a method of providing asynchronous web-based active technical support from a support provider to a user of an electronic device during a support session, the method comprising receiving device-specific data to assist the support provider in responding to a support query, dispatching a polling application operative to poll the support provider for a response to the query and notifying the user that a response has become available, the polling application being dispatched, from or on behalf of the support provider, in response to an instruction generated using a trusted applet.

The applet may be a Java applet or “Active X” code.

The invention, in its second aspect, may comprise one or more of the features described in relation to the first aspect.

In accordance with a third aspect of the present invention, there is provided a server-side technical support source comprising a web server to participate in asynchronous messaging with a client-side device, the support source being operative to supply, to the device, a polling application whereby repeated polling of the support source for a response to a support query may be effected, the polling application being supplied to the device using a trusted applet. The applet may be a Java applet or “Active X” code.

The invention, in its third aspect, may comprise one or more of the features described in the preceding paragraphs.

In accordance with a fourth aspect of the present invention there is provided a software element for use in the provision of technical support to a user of a data-processing device which, in response to an indication of trust being given by the user, is operative to effect or permit a download of a polling element whereby a support provider may be polled, on a repeated and automated basis, for a response to a support query.

The software element may be a software element in the form of an applet, such as a Java applet or “Active X” code, the polling element being transmissible from the support provider using HTTP.

In preferred embodiments, the polling element may have a data footprint of no more than about 50 KB.

### BRIEF DESCRIPTION OF THE DRAWINGS

Specific embodiments of the invention, in its various aspects, will now be described in greater detail, but strictly by way of example only, by reference to the accompanying drawings, of which:

FIG. 1 is a schematic illustration of a web-based support system;

FIG. 2 is a flow diagram illustrating the major steps of the technical support process;

FIG. 3 is a continuation of the flow diagram of FIG. 2; and

FIG. 4 is a flow diagram showing, in more detail, the installation, operation and removal of the polling application.

### DETAILED DESCRIPTION OF THE DRAWINGS AND BEST MODE OF THE INVENTION

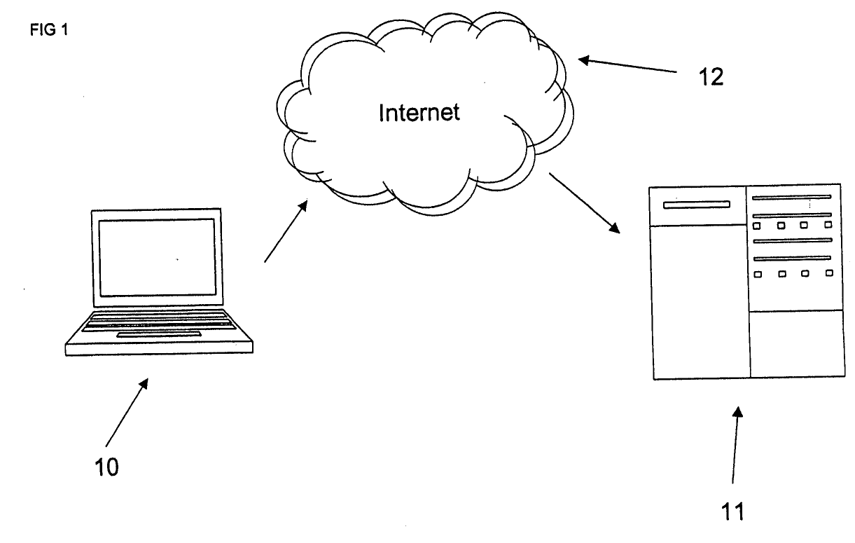

As explained in the introduction, this invention relates generally to a technical support service whereby a user of a client device such as a PC 10 may interact with a support provider 11 via a web-based connection indicated generally at 12— see FIG. 1.

More particularly, the invention relates to an asynchronous support process by which support queries and responses are passed from and to the user on a periodic basis. In parallel with a user/support specialist “chat session”, information concerning the configuration of the user's device is sent to the support provider so that an appropriate diagnosis of an apparent fault can be made.

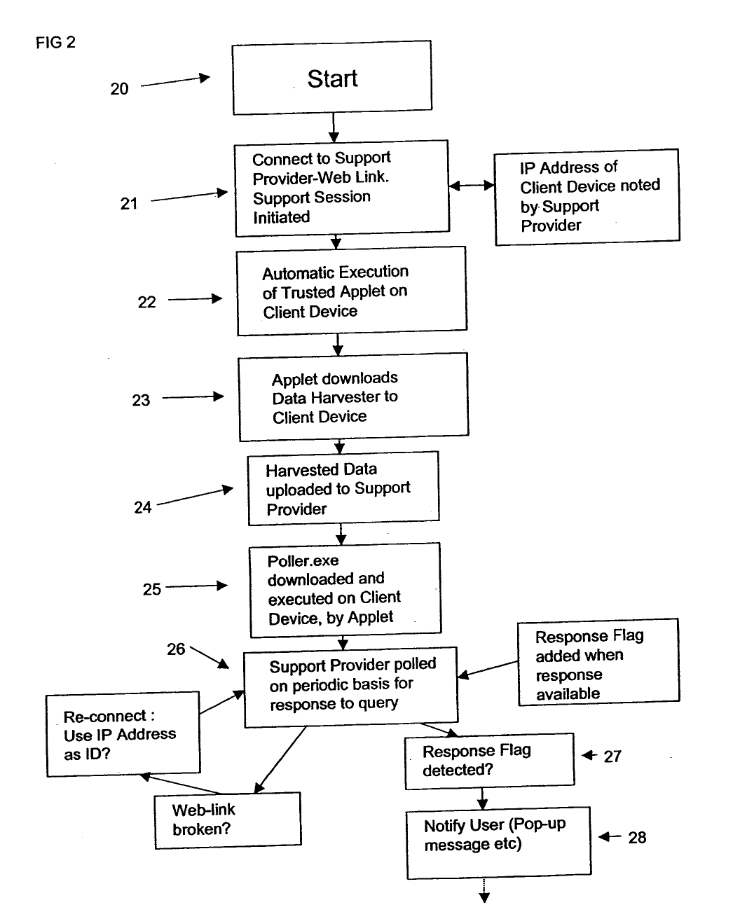

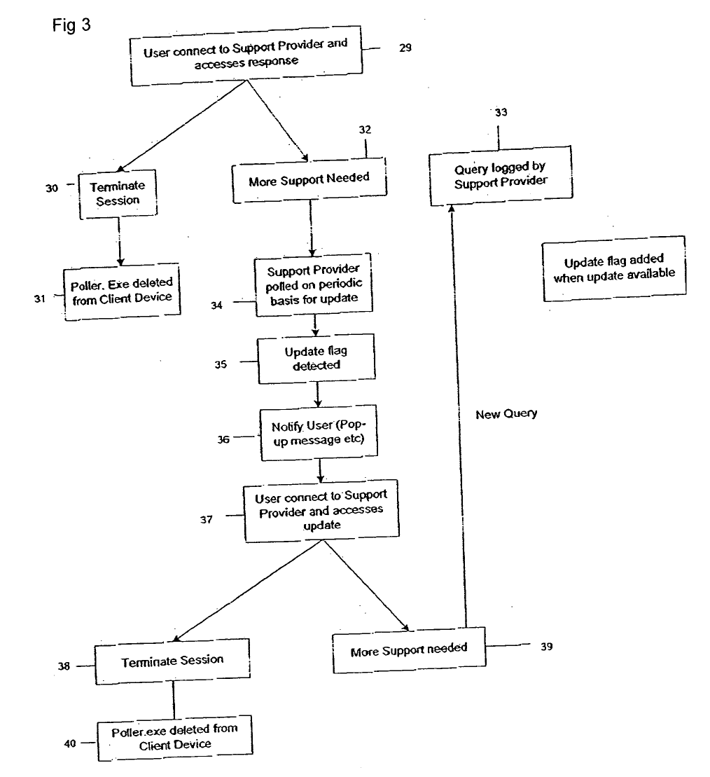

This is shown, in a step-wise manner, in FIGS. 2 and 3.

Commencing at the start 20, a web-based connection is established between the user's device (e.g. PC 10) and a support provider 11, which, in this example, is constituted by a web server. The connection step 21 thus initiates an HTTP-based support session, with the client device being “identified” to the support server using a unique identifier such as a randomly-generated number or string, or GUID (Global Unique Identifier), for example. It will of course be understood that other identification methods could equally be utilised. Once an appropriate web link has been established to the URL of the support provider, with a support page thus being displayed by a browser application loaded on the client device, an execution step 22 occurs, in which an applet, obtained from the web server, executes from within the browser application on the client device. As will be understood, the applet could be a Java applet, Microsoft “Active X” code, or the like. Before this execution occurs, however, the user must confirm that he/she is happy to trust the applet, bearing in mind that execution thereof will lead to data gathering operations. The trustworthiness of the applet may be verified in a number of generally conventional ways, such as by virtue of a third party digital signature approach (as offered commercially by Verisign, Inc.), thus guaranteeing that the applet code is safe, and virus-free. The user may thus be presented with a query “pop-up” box, seeking confirmation that the applet is trusted and that it may thus be executed. This is shown at 21a. This level of trust is important as the applet, in the subsequent steps of the support method, will be required to operate outside its Java “sandbox”, thus potentially gaining access to sensitive areas of the client device. As will be understood by those well-versed in Java programming terminology, a “sandbox” is the programme space and set of rules that developers employ when Java code (such as applets) is produced. Applets, being sent automatically as an integral part of a web page, and being executable upon receipt of the HTML code by a client browser, have the potential to do harm either involuntarily or as the result of a malicious act. In brief, the “sandbox” limitations restrict the type of system resources that can be sought or obtained by the Applet meaning that the Java code is free to operate in a confined area but not beyond the boundaries of this area without express consent first being provided. In the case of the present invention, the diagnostic aspect thereof may require that sensitive configuration information is obtained from the client device which, in the hands of a non-trusted entity, could pose serious security concerns. The term “sandbox” is also known, in some circles, as a “confined runtime environment”.

On the basis of this trust, a download step 23 then occurs, during which the applet downloads a small footprint data harvester to the client device, whereby configuration, software/hardware settings and other device specific data are gathered, and subsequently uploaded (see step 24) to the support provider. It will be understood, of course, that this configuration information is required, by the provider, in order for a meaningful diagnosis of any fault or operational difficulty, to be effected. Examples of this general type of data harvester are shown at 4developers.com (see “Support Fetchdog”).

As it may be that a support technician associated with the support provider is not able to provide an immediate response, the user of the device, in accordance with the present invention, is able to effect a disconnection of the web link, whilst maintaining the support session in an active state. Thus, the user, at this point, may close his/her browser application, opting to return to the support session at a later time, if appropriate. As explained above, the service provider has, by now, been provided with an identifier of the client device, meaning that a subsequent “call” to the URL of the support provider will enable the support provider to identify the device and thus to “retrieve” the support call information already conveyed by the device.

So that the user is spared the somewhat laborious task of repeatedly accessing the support provider URL, to determine whether or not a response to his/her query is yet available, the invention provides that the trusted applet effects a download of a relatively lightweight (both in terms of data size and computational demand) polling application (“poller.exe”), as shown at step 25. This polling application is operative, on a repeated basis, to poll the support provider URL, and to notify the user as and when a response becomes available. This is shown generally at step 26.

In a preferred embodiment, the polling may be effected on a periodic basis, in that the polling is repeated at a suitable frequency, but it will of course be understood that other arrangements are possible and within the scope of the present disclosure.

So that the support provider can indicate when a response becomes available, use is made of a response flag which is added to the appropriate support provider URL as and when a response becomes available. This flag is detected by the polling application, with detection of the flag causing the polling application to notify the user of that fact, such as by way of a “pop-up” message, audible notification, e-mail or the like—this is shown at steps 27 and 28.

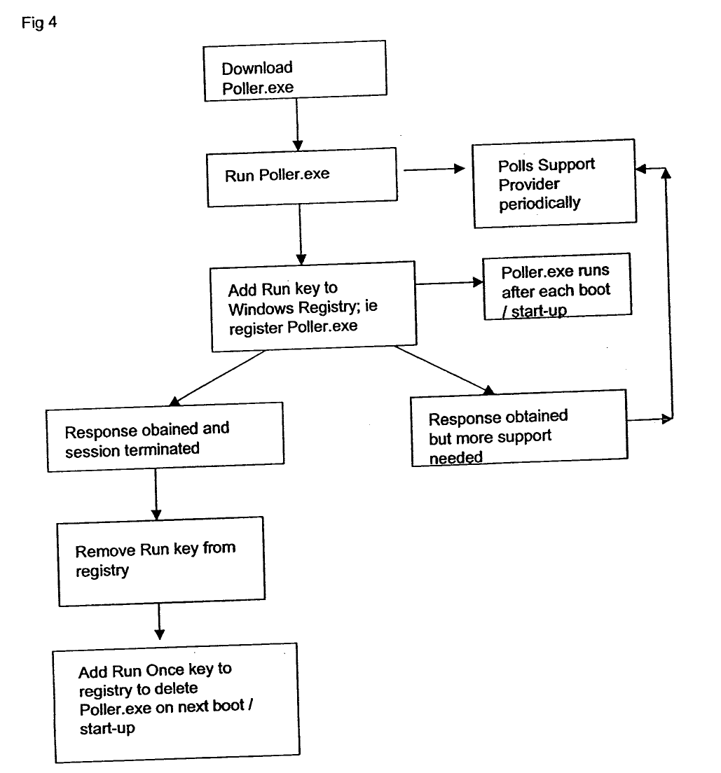

Upon receipt of this notification (see FIG. 3), the user then reconnects to the support provider URL, to access the posted response—see step 29. At that point, it may be that the user has sufficient information to remedy the fault or overcome the technical difficulty, meaning that a session termination step 30 may then occur, leading to a deletion step 31, at which the polling application is removed from the client device. This deletion is explained in more detail with reference to FIG. 4.

Alternatively, it may be that additional support is needed (see step 32) meaning that a new query is generated, and passed to the support provider, as shown at step 33.

It will be understood that it then becomes necessary, once again, for the user to be notified once an update on his/her query becomes available, and a further polling step 34 is thus undertaken, on a repeated basis, with the polling application then being operative to detect an update flag added, by the support provider, to the support provider URL. As shown in steps 35 and 36, detection of such an update flag leads to the user being notified of that fact, again perhaps using a pop-up message, audible notification or e-mail, for example. Once again, (see step 37), the user then reconnects to the support provider URL, to access the update, with the additional information conceivably being sufficient for the session, then, to be terminated—see step 38. On the other hand, it may be that still more support is needed (step 39) meaning that a still further query is passed to the support provider, with the query/polling/flag sequence then repeating in an iterative manner, until the problem is resolved. As shown at step 40, the polling application is deleted from the client device once the iterative session has been brought to a conclusion.

Referring next to FIG. 4, this illustrates, in more detail, the download, execution and deletion steps associated with the polling application “poller.exe”.

As explained in relation to FIGS. 2 and 3, “poller.exe” is downloaded, under the authority of a trusted applet, with execution of the polling application causing a repeated polling of the support provider, so as to notify the user as and when a response/update becomes available.

So that the polling application is executed even after a system boot/start-up process, the trusted applet installs, in a registry of the device (on a windows PC, in the Windows Registry), a “Run” key so that the device executes “poller.exe” each time it is booted or restarted. This, of course, allows a user to disconnect from the support provider URL or even to power-down the device concerned, without losing the polling functionality of the support system.

Where a response received from the support provider is sufficient to solve the user's problem or to allay any concerns that the user may have, the support session is then terminated, with the polling application then being operative to remove the “Run” key from the device registry, and to add a “Run Once” key to the registry, whereby a “delete poller.exe” command is executed upon subsequent boot/start-up of the device concerned. With the poller.exe application thus deleted, it will be understood that the device is left “clean”, in that no unnecessary code should remain on the device that was not present prior to the support session being initiated.

As will be appreciated from the foregoing, the invention provides a transparent support system (in that the user is not necessarily made aware of the fact that any data harvesting/polling applications have been downloaded) and which is computationally lightweight from a client-side viewpoint, in that the data harvesting and polling applications have a relatively small data footprint, conveniently in the order of 50 KB.

Moreover, the automatic polling facility offered by the invention allows a user to disconnect from a support session, with the device thus undertaking the repetitive task of checking for any query responses or updates, and with an automated notification being passed to the user in the event that a response/update is detected. The addition, in the device's registry, of “Run” and, subsequently, “Run Once” keys, allow the polling application to be executed on a continuing basis, up until it is no longer required, at which point the application is removed from the user's device, leaving the system “clean” for future use.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of obtaining technical support for a data-processing device, comprising initiating a support session during which device-specific data is conveyed from the device to a support provider to assist the support provider in responding to a support query, and polling the support provider for a response to the query, on a repeated and automated basis, until a response becomes available or the support session is terminated.

2. A method according to claim 1 wherein the polling is effected by a polling application obtained from the support provider.

3. A method according to claim 2 wherein the polling application, during the support session, is executed subsequent to each boot or start-up sequence of the device.

4. A method according to claim 2 wherein the polling application, during the support session, is stored on or on behalf of the device, in a manner whereby the application is executed subsequent to each boot or start-up sequence of the device.

5. A method according to claim 3 wherein, in a Windows O.S. environment, a Run key located in or operatively associated with the registry of the device is used to execute the application, subsequent to each said boot or start-up sequence.

6. A method according to claim 5 wherein, upon termination of the support session, the Run key is removed or disabled.

7. A method according to claim 6 wherein the application subsequently is deleted using a delete command executed in accordance with a Run Once key located in or operatively associated with the registry.

8. A method according to claim 2 wherein the support session is established using a web connection and wherein the polling application is downloaded from the support provider using an applet.

9. A method according to claim 8 wherein the applet is operative to download a data harvester to gather the device-specific data.

10. A method according to claim 8 wherein the applet is used only in response to an indication of trust being given by a user of the device.

11. A method according to claim 10 wherein the support provider conveys to the user a trust request, agreement to the request allowing execution of the applet.

12. A method according to claim 1 wherein the polling is effected using HTTP.

13. A method of providing asynchronous web-based active technical support from a support provider to a user of an electronic device during a support session, the method comprising receiving device-specific data to assist the support provider in responding to a support query, dispatching a polling application operative to poll the support provider for a response to the query and notifying the user that a response has become available, the polling application being dispatched, from or on behalf of the support provider, in response to an instruction generated using a trusted applet.

14. A server-side technical support source comprising a web server to participate in asynchronous messaging with a client-side device, the support source being operative to supply, to the device, a polling application whereby repeated polling of the support source for a response to a support query may be effected, the polling application being supplied to the device using a trusted applet.

15. A software element for use in the provision of technical support to a user of a data-processing device which, in response to an indication of trust being given by the user, is operative to effect or permit a download of a polling element whereby a support provider may be polled, on a repeated and automated basis, for a response to a support query.

16. A software element according to claim 15 in the form of an applet, the polling element being transmissible from the support provider using HTTP.

17. A software element according to claim 16 wherein the polling element has a data footprint of no more than about 50 KB.

18. A method of obtaining technical support for a data-processing device, comprising: establishing a support session using a web connection during which device-specific data is conveyed from the device to a support provider to assist the support provider in responding to a support query; downloading a polling application from the support provider using a trusted applet and polling, using the polling application, the support provider for a response to the query, on a repeated and automated basis, until a response becomes available or the support session is terminated.

19. A method according to claim 18 wherein the polling application, during the support session, is executed subsequent to each boot or start-up sequence of the device.

20. A method according to claim 18 wherein the applet is operative to download a data harvester to gather the device-specific data.
